(19) United States
(12) Patent Application Publication
(10) Pub. No.: US 2018/0005144 A1
(43) Pub. Date: Jan. 4, 2018

(54) DELAYING RIDES PRE-ARRANGED WITH RIDESHARING SERVICES

(71) Applicant: RideSage Inc., Emeryville, CA (US)

(72) Inventors: Paul Lo, San Jose, CA (US); Andrew Tsukahira, Los Angeles, CA (US); Henry Vogel, Saratoga, CA (US)

(73) Assignee: RideSage Inc., Emeryville, CA (US)

(21) Appl. No.: 15/624,079

(22) Filed: Jun. 15, 2017

Related U.S. Application Data
(60) Provisional application No. 62/357,455, filed on Jul. 1, 2016.
(60) Provisional application No. 62/356,001, filed on Jun. 29, 2016.

(51) Int. Cl. G06Q 10/02; G06Q 10/04; G06Q 30/02; G06Q 50/30

(52) U.S. Cl. CPC G06Q 10/025; G06Q 50/30; G06Q 10/047; G06Q 30/0284

(57) ABSTRACT

Some embodiments enable a traveler to delay a ride which was previously arranged with a ridesharing service. For example, a traveler may be notified when the time for a previously arranged ride is approaching, and may indicate that the ride should be delayed by a short period. Some embodiments may enable the traveler to request a short delay with minimal effort and thought, so that if he/she is otherwise occupied when notified, he/she may quickly and easily delay the ride without having to divert his/her full attention from other tasks.

### RELATED APPLICATIONS

This application claims priority under 35 U.S.C. §119(e) to U.S. Provisional Patent Application Ser. No. 62/356,001, entitled “Delaying Rides Pre-Arranged With Ridesharing Services,” filed Jun. 29, 2016, bearing Attorney Docket No. B1453.70002US00, and to U.S. Provisional Patent Application Ser. No. 62/357,455, entitled “Delaying Rides Pre-Arranged With Ridesharing Services,” filed Jul. 1, 2016, bearing Attorney Docket No. B1453.70005US00. The entirety of each of the documents listed above is incorporated herein by reference.

### BACKGROUND

Commonly assigned U.S. Provisional Patent Application Ser. No. 62/335,234, filed on May 13, 2016, entitled “Systems And Methods For Managing Travel Options” (hereinafter “the '234 application,” which is also incorporated herein by reference in its entirety), discloses functionality which enables a traveler to reserve a ride through a ridesharing service at a time prior to the ride occurring (e.g., several hours prior, a day or more prior, etc.). Users of this functionality may specify a time at which a driver with a ridesharing service is to pick the user up at a specified origin location.

### SUMMARY

The Assignee has appreciated that, for many reasons, a user of the system disclosed in the '234 application may find it convenient to delay a previously reserved ride. For example, a traveler may feel confident when reserving a ride that he/she will be ready to leave when the appointed time arrives, but may later find as that time approaches that they need to delay the ride by a short period. This can be problematic, because ridesharing services conventionally allow drivers to cancel a ride if the traveler is not ready to leave within a certain amount of time after the scheduled time for the ride arrives. If a ride is cancelled by the driver, the traveler must then book a new ride, and wait for a new driver to arrive at his/her location. This can be time-consuming and frustrating for travelers.

Some embodiments of the invention provide functionality which is akin to a “snooze button” for allowing a traveler to delay a ride which was previously arranged with a ridesharing service. For example, some embodiments of the invention may provide functionality for notifying a traveler when the time for a previously arranged ride is approaching, and allowing the traveler to indicate that the ride should be delayed by a short period. Some embodiments of the invention may provide a mechanism designed to allow the traveler to request a short delay with minimal effort and thought, so that a traveler who is otherwise occupied when he/she is notified that the scheduled time for a previously arranged ride is upcoming may quickly and easily delay the ride without having to divert his/her full attention from whatever tasks he/she was previously performing.

Additionally or alternatively, some embodiments of the invention may provide functionality which a traveler may employ to communicate directly with a driver for a pre-arranged ride. A traveler may employ such functionality to, for example, let a driver know that he/she will be a couple of minutes late, talk to the driver to convey information or ask a question, or otherwise interact with the driver. In this respect, some embodiments of the invention acknowledge that enabling a traveler to communicate with a driver to let the driver know that he/she is on the way may make it less likely that the driver will cancel a pre-arranged ride.

The foregoing is a non-limiting summary of only certain aspects of the invention, some embodiments of which are described in the sections that follow.

### BRIEF DESCRIPTION OF DRAWINGS

The accompanying drawings are not intended to be drawn to scale. In the drawings, each identical or nearly identical component illustrated in the various figures is represented by a like numeral. For purposes of clarity, not every component may be labeled in every drawing. In the drawings:

FIG. 1 depicts a representative process for notifying a traveler of an upcoming pre-arranged ride with a ridesharing service and enabling the traveler to delay the ride, in accordance with some embodiments of the invention;

FIGS. 2-5 depict representative screen interfaces which a traveler may use to manage aspects of a ride pre-arranged with a ridesharing service, in accordance with some embodiments of the invention;

FIG. 6 depicts a representative process for enabling a traveler to communicate directly with a driver of a pre-arranged ride, in accordance with some embodiments of the invention;

FIGS. 7-12 depict representative screen interfaces which a traveler may use to communicate with a driver of a pre-arranged ride, in accordance with some embodiments of the invention;

FIG. 13 is a block diagram depicting a representative system architecture for providing functionality relating to enabling travelers to manage transportation options, in accordance with some embodiments of the invention; and

FIG. 14 is a block diagram depicting a representative computer system which may be used to implement some aspects of the invention.

### DETAILED DESCRIPTION

In some embodiments, functionality which is akin to a “snooze button” is provided to enable a traveler to delay a ride which was previously arranged with a ridesharing service. For example, in accordance with some embodiments, a traveler may be notified when a previously scheduled time for a ride is approaching, and allowed to delay the ride by a short period. In some embodiments, the mechanism by which a traveler delays a previously scheduled ride may require minimal effort, thought and attention, so that a traveler may delay a ride quickly and easily and without diverting significant attention from whatever tasks previously occupied him/her. Some embodiments of the invention may enable a traveler to communicate directly with a driver for a pre-arranged ride, such as to notify a driver (e.g., via text message, voice call, etc.) that he/she will be a couple of minutes late for a pre-arranged ride, to discourage the driver from cancelling the ride if the traveler is not ready to leave at the scheduled time.

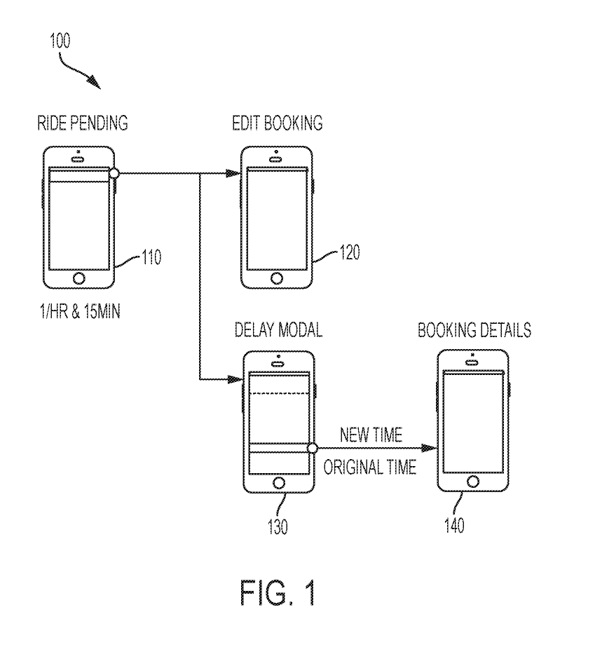

FIG. 1 depicts a representative process 100 for allowing a traveler who has scheduled a ride with a ridesharing service in advance to delay the ride by a short period. As FIG. 1 indicates, representative process 100 may involve interaction between a traveler and a mobile device. Any suitable mobile device may be used, such as a smartphone, tablet, personal (e.g., laptop) computer, smartwatch, gaming console, and/or any other suitable mobile device(s), whether now known or later developed. In some embodiments, the mobile device may execute one or more apps, applications and/or other computing components. It should be appreciated that, in some embodiments, the component(s) executing on the mobile device may communicate via one or more networks (not shown) with one or more remote components executing on one or more remote servers (also not shown). As a result, representative process 100 may involve interaction between the computing component(s) executing on the mobile device and the remote computing component(s) over the network(s) to provide the functionality described herein. It should also be appreciated that this functionality may be distributed, logically and/or physically, in any suitable manner across the component(s) executing on the mobile device and the remote component(s) executing on the remote server(s). The invention is not limited to any particular mode of implementation.

In representative process 100, a traveler has reserved a ride, but no driver has yet “accepted” (i.e., agreed to perform) the ride. This may be for several reasons. For example, the '234 application discloses a system which, in some implementations, allows a traveler to request a ride a significant period of time in advance of the ride occurring, but may not actually submit the ride request to a ridesharing service for fulfillment until a short period before the ride is to occur. Thus, one reason why a driver may not have accepted a particular ride is that a request for the ride has not yet been submitted to the driver's ridesharing service. Another reason is that a request for the ride may have been submitted to a ridesharing service, but no driver may have yet indicated availability for the ride. There may be any number of reasons why a ride has not yet been accepted.

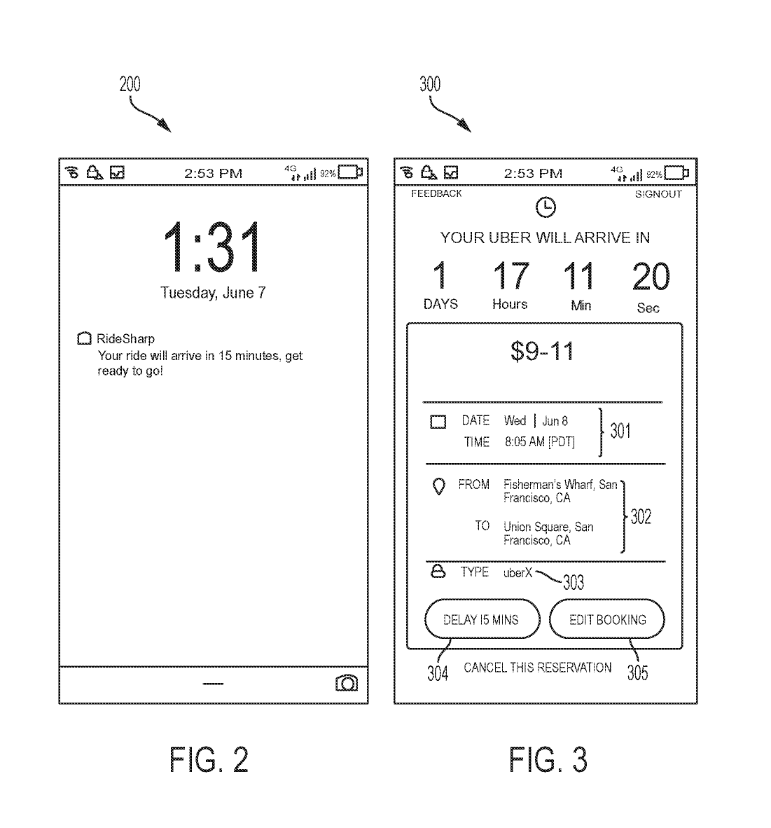

At the start of representative process 100, the traveler is notified that the scheduled time for a pre-arranged ride is approaching at 110. For example, in some embodiments, the traveler may be notified of an upcoming scheduled time for a ride at predetermined intervals prior to the scheduled time. For example, a traveler may be automatically notified one hour prior to the scheduled time for a ride, fifteen minutes prior to the scheduled time, etc., to prevent the traveler from forgetting about the ride. A notification may be sent to the traveler in any suitable way, and may include any suitable information. FIG. 2 depicts a representative notification 200 which is presented on a “home screen” of a mobile device employed by a traveler. Other techniques may involve notifications which include different information and/or are presented in different ways.

In some embodiments of the invention, a traveler's input in response to a notification (e.g., a tap, a swipe, voice input, etc.) may cause information relating to the prearranged ride to be presented, along with options to delay the ride, or to otherwise edit details relating to the ride. A representative screen interface 300 which may be shown to a traveler who provides input to a notification is depicted in FIG. 3. Representative screen interface 300 includes the date and time for a pre-arranged ride at 301, the origin and destination location for the ride at 302, the applicable ridesharing service at 303, and options to delay the ride and edit the booking at 304 and 305, respectively. Of course, any suitable information relating to a pre-arranged ride may be presented to a traveler, in any suitable way.

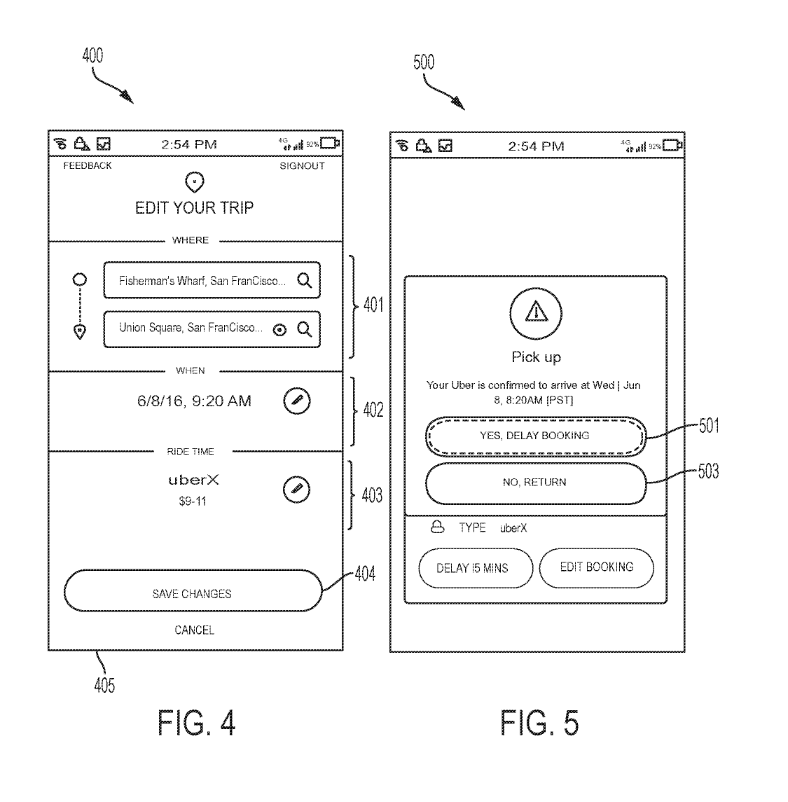

Returning to representative process 100 shown in FIG. 1, if the traveler provides input indicating that he/she would like to edit details relating to the pre-arranged ride (e.g., by supplying input to button 305 on representative screen interface 300), then the process proceeds to 120, wherein the traveler is allowed to edit the booking. A traveler may edit a booking in any of numerous ways. A representative screen interface 400 which allows a traveler to edit various details relating to a booking is shown in FIG. 4. Representative interface 400 allows the traveler to edit the origin or destination location for the booking at 401, the time of the booking at 402, and the ridesharing service at 403. Any suitable form of input may be provided to edit information on a booking, including touch input, typewritten input, voice input, etc. The traveler may then save any changes made to the booking by providing input to button 404, or cancel the changes to the booking by providing input at 405.

If the traveler would like to simply delay the start of a pre-arranged ride by a set amount of time, instead of expending the time and effort involved in performing the editing process described above with reference to FIG. 4, then the traveler may supply input to button 304 (FIG. 3). In the example shown in FIG. 3, the traveler may a delay the ride by fifteen minutes, although any suitable period of time may alternatively be specified.

If the user provides input to button 304, then representative process 100 proceeds to 130, wherein a modal is presented on the screen interface of a mobile device employed by the user. A representative modal is shown in FIG. 5, in which representative screen interface 500 presents options for the traveler to confirm that the booking is to be delayed by fifteen minutes by providing input to button 501, or to return to the previous interface (in the example shown, screen interface 300) by providing input to button 502. Of course, a modal may present any suitable information, in any suitable way, and allow for any suitable form(s) of input, as the invention is not limited to the specific implementation shown in FIG. 5. Representative process 100 then completes.

As noted above, the representative process 100 shown in FIG. 1 is for enabling a traveler to delay a pre-arranged ride which has not yet been accepted by a driver with a ridesharing service. The Assignee has appreciated that after a driver accepts the ride, a traveler's options for changing a ride may be more restricted, and making changes may be more complicated, given that the driver has now agreed to the appointed starting location and time and may be on the way. As a result, delaying the ride may entail more than merely sending a new desired time for the ride to the driver's ridesharing service. As such, some embodiments of the invention provide travelers with functionality for communicating with a driver after the driver has accepted the ride, so that the traveler may convey any changes directly. The Assignee has appreciated that allowing the traveler to convey any changes directly to the driver may dissuade the driver from cancelling the ride.

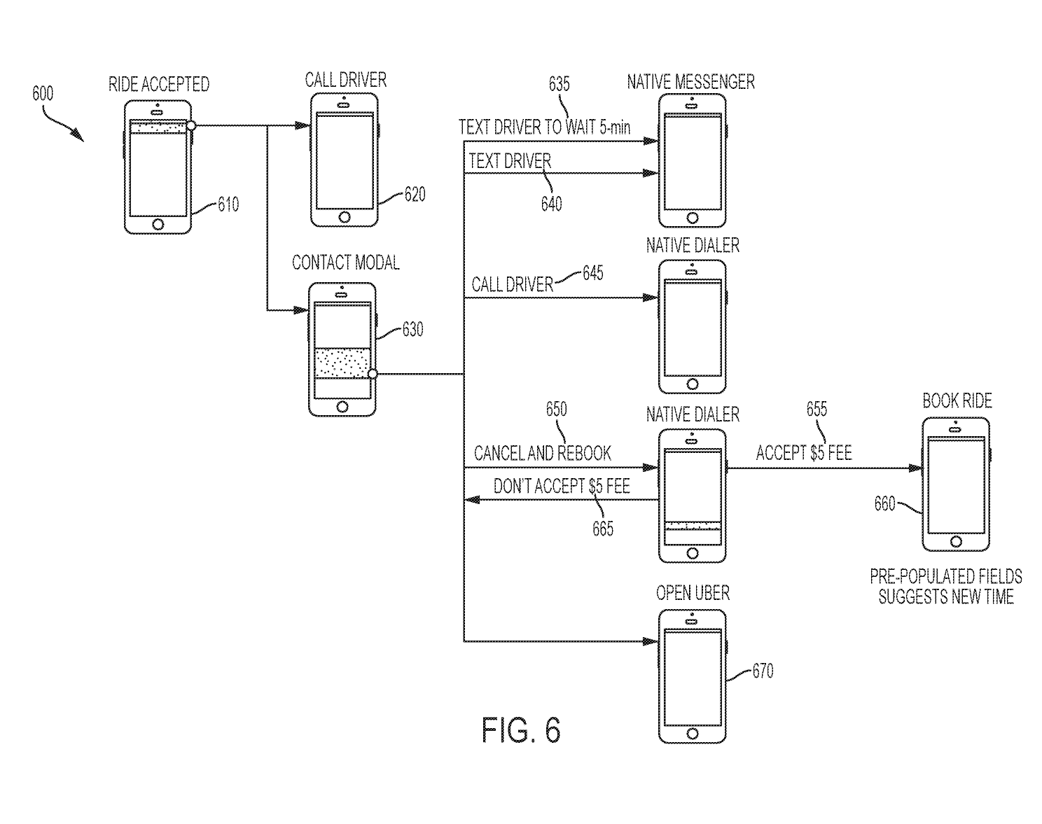

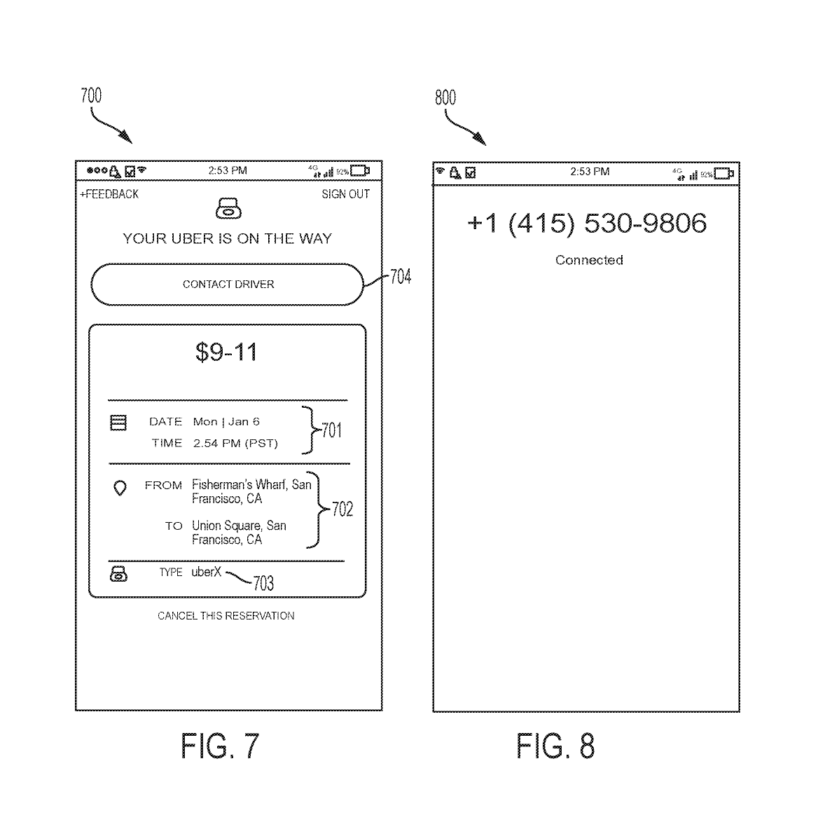

FIG. 6 depicts representative process 600 for enabling a traveler to modify various details relating to a ride which has been accepted by a driver. Representative process 600 begins at 610, in which a prearranged ride is accepted by the driver. In some embodiments, the traveler may be notified when the driver accepts the ride, since this may indicate that the driver is on the way. A representative screen interface 700 for notifying a traveler that a driver has accepted a ride is shown in FIG. 7. Representative screen interface 700 presents information including the scheduled date and time of the ride at 701, the origin and destination location at 702, and the ridesharing service at 703.

In some embodiments of the invention, a screen interface which is used to notify a traveler that a ride has been accepted may also enable the traveler to initiate a call to the driver. In representative process 600, if the traveler indicates a desire to call the driver, then the process proceeds to 620, wherein the call is placed. For example, the driver's telephone number may be automatically pre-populated into an input facility used by the mobile device's native dialer, and used to place a call. A representative screen interface 800 which may be shown to the traveler when the call is placed is shown in FIG. 8.

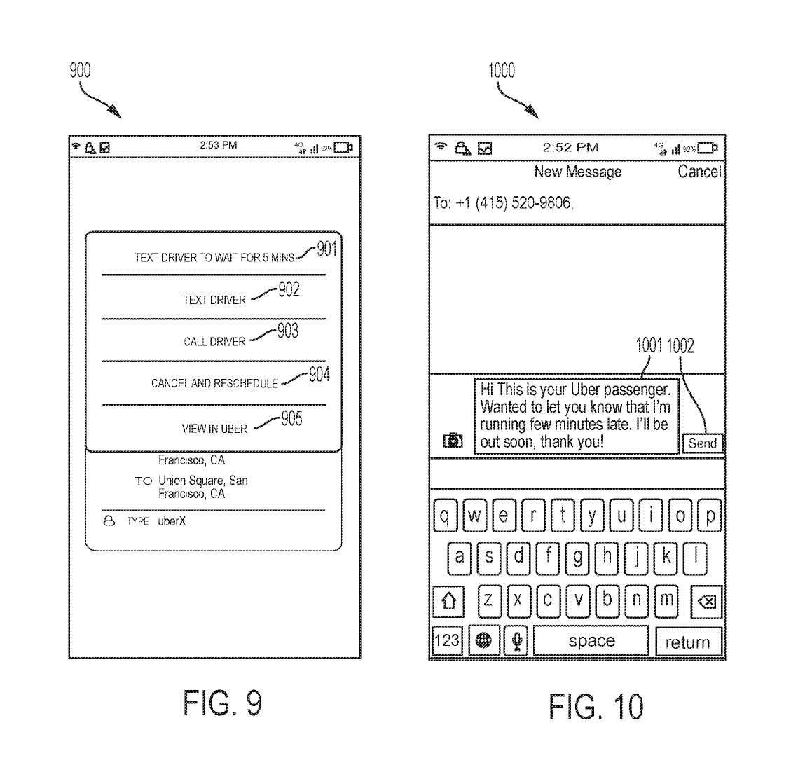

If a traveler who is shown representative screen interface 700 provides input to button 704 to contact the driver, representative process 600 proceeds to 630, wherein a contact modal is presented. A representative contact modal 900 is shown in FIG. 9. In the example shown in FIG. 9, a traveler may send a text to the driver to wait five minutes by providing input at 901, send other information to the driver via a text message by providing input at 902, call the driver by providing input at 903, cancel and reschedule the ride by providing input at 904, and view details relating to the ride in a ridesharing service app by providing input at 905. Of course, a contact modal may provide any contact option(s), and the invention is not limited to those shown in representative screen interface 900.

By providing input to representative contact modal at 901, the traveler may send a predefined text message to ask the driver to wait for five minutes, thereby causing representative process 600 (FIG. 6) to proceed to 635. FIG. 10 depicts a representative screen interface 1000 which may then be shown to the traveler. In representative screen interface 1000, a predefined message has been pre-populated in message text box 1001, which the traveler may cause the mobile device's native messenger functionality to send by providing input at 1002. Using this functionality, the traveler may quickly and easily alert the driver that he/she will arrive shortly, thereby discouraging the driver from cancelling the ride.

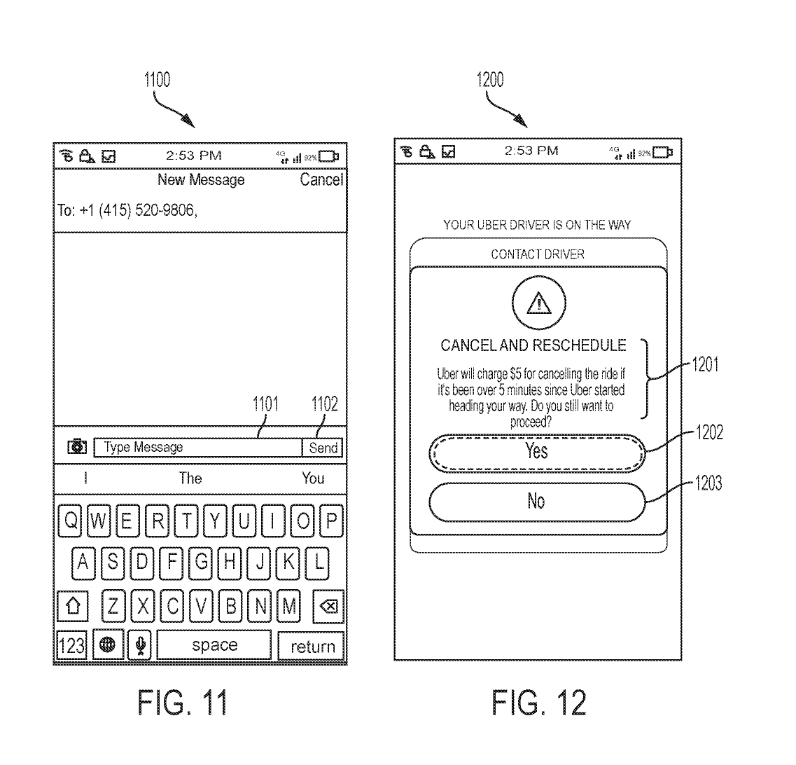

By providing input to representative contact modal 900 at 902, the traveler may send a non-predefined text to the driver, such as to convey information other than that the traveler will be a couple of minutes late. FIG. 11 depicts representative screen interface 1100 which may be shown if this option is selected. The traveler may then supply input to message text box 1101 defining a text message to be sent, and then cause the message text to be sent by providing input at 1102.

By providing input at 903, the traveler may indicate that he/she wishes to call the driver, thereby causing representative process 600 (FIG. 6) to proceed to 645. As in step 620 described above, doing so may cause the mobile device's native dialer functionality to be launched, and the driver's telephone number to be automatically provided to the mobile device's native dialer so that the call may be placed with minimal input by the traveler. Representative screen interface 800 shows the driver's number having been pre-populated to the mobile device's native dialer functionality.

By providing input at 904, the traveler may cancel and reschedule the ride, thereby causing representative process 600 to proceed to 650. In this respect, the Assignee has appreciated that cancelling a ride which has already been accepted by a driver may cause the traveler to incur ridesharing service fees, and so representative screen interface 1200 (FIG. 12) presents information on fees imposed for cancelling an accepted ride. Representative screen interface 1200 also presents information on ridesharing service policies 1201, allows the traveler to confirm cancellation by providing input at 1202, and allows the traveler to rescind cancellation by providing input at 1203. By providing input at 1202, the traveler causes representative process 600 to proceed to 655, wherein the cancellation fee is accepted, and then to 660, wherein the ride may be rescheduled. By providing input at 1203, the traveler causes representative process 600 to proceed to 665, wherein a cancellation fee is not imposed, and the contact modal shown in FIG. 9 is redisplayed to the traveler.

By providing input at 905, the traveler may access information on the ride via a ridesharing service app, thereby causing representative process 600 to proceed to 670, wherein the ridesharing service app is opened. Representative process 600 then completes.

It should be appreciated that although representative processes 100 (FIG. 1) and 600 (FIG. 6) are described above as starting with a notification to a traveler (i.e., that the scheduled time for a prearranged ride is upcoming, or that a ride has been accepted by a driver), the invention is not limited to such an implementation. For example, some embodiments of the invention may provide access to functionality like that which is described above when a rider opens an app, or accesses one or more other components providing ridesharing-related functionality.

It should also be appreciated that numerous variations on the processes described above with reference to FIGS. 1 and 6 are possible. For example, the acts described above with reference to either process need not be performed in the particular order described. Additionally, either process may include additional acts not described above, and/or may not include all of the acts described above. Any of numerous modifications may be envisioned.

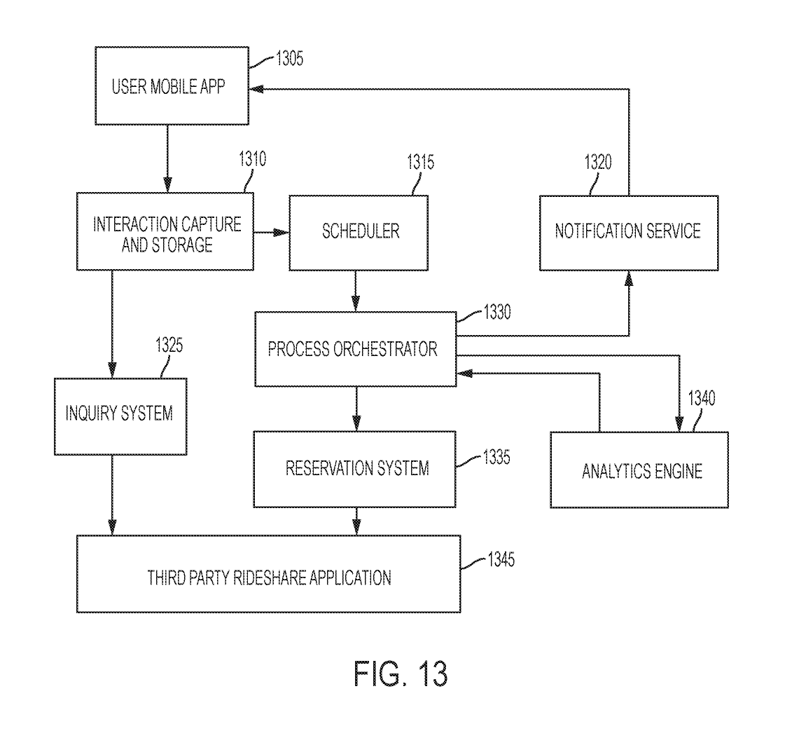

As noted above, in some embodiments of the invention, one or more computing components executing on a traveler's mobile device may communicate with one or more components executing on one or more remote computing devices, such as one or more server computers. In some embodiments of the invention, the component(s) executing on the remote computing device(s) may exchange information with a third-party rideshare application, such as which may be made available by a ridesharing service. FIG. 13 depicts a representative architecture for components which provide functionality of the type described above.

In the architecture shown in FIG. 13, interaction capture and storage module 1310 receives information from user mobile app 1305, such as input provided by a traveler to the app to specify the details of a ride. Interaction capture and storage module 1310 provides information relating to a ride to be scheduled to scheduler module 1315, which may, in some embodiments, determine details about a scheduled trip based on other information about the trip provided by the user.

Process orchestrator module 1330 receives information on scheduled trips from schedule module 1315, and orchestrates communication amongst other modules to keep the traveler informed as to the trip, and to communicate with a third party rideshare application to reserve the trip. For example, process orchestrator module 1330 may communicate information via reservation system module 1335 to third-party rideshare application 1345, and communicate information via notification service module 320 to the user mobile app 305 employed by a traveler. As such, process orchestrator module 1330 may interact with user mobile app 305 to provide any or all of the functionality described above with reference to FIGS. 1 and 6, and communicate any changes to pre-arranged rides to third-party rideshare application 1345 so that information may then be conveyed to one or more ridesharing service drivers.

In the representative architecture shown in FIG. 13, process orchestrator module 330 may provide information on rides to analytics engine 340 to glean insights from such information. For example, analytics engine 340 may process feedback received from travelers on completed rides, delays to rides, etc. to cause process orchestrator 330 to modify the manner in which travelers are notified of upcoming trips. Analytics engine 340 may also process traveler feedback received on the user mobile app 305, and this feedback may be employed in any various ways to modify the information which is presented to travelers via the third-party rideshare app by providing such information to process orchestrator 330.

Interaction capture and storage module 310 also provides information received from user mobile app 305 to inquiry system 325, which communicates with third party rideshare application 345 to determine whether travelers have the existing accounts with the third party ride share application. For example, if a user of the mobile app 305 indicates that he/she has an existing account with a third party ride share application, such indication may be provided to interaction capture and storage module 310, which may inquire via inquiry system 325 with third party ride share application 345 to verify the traveler's account with the application.

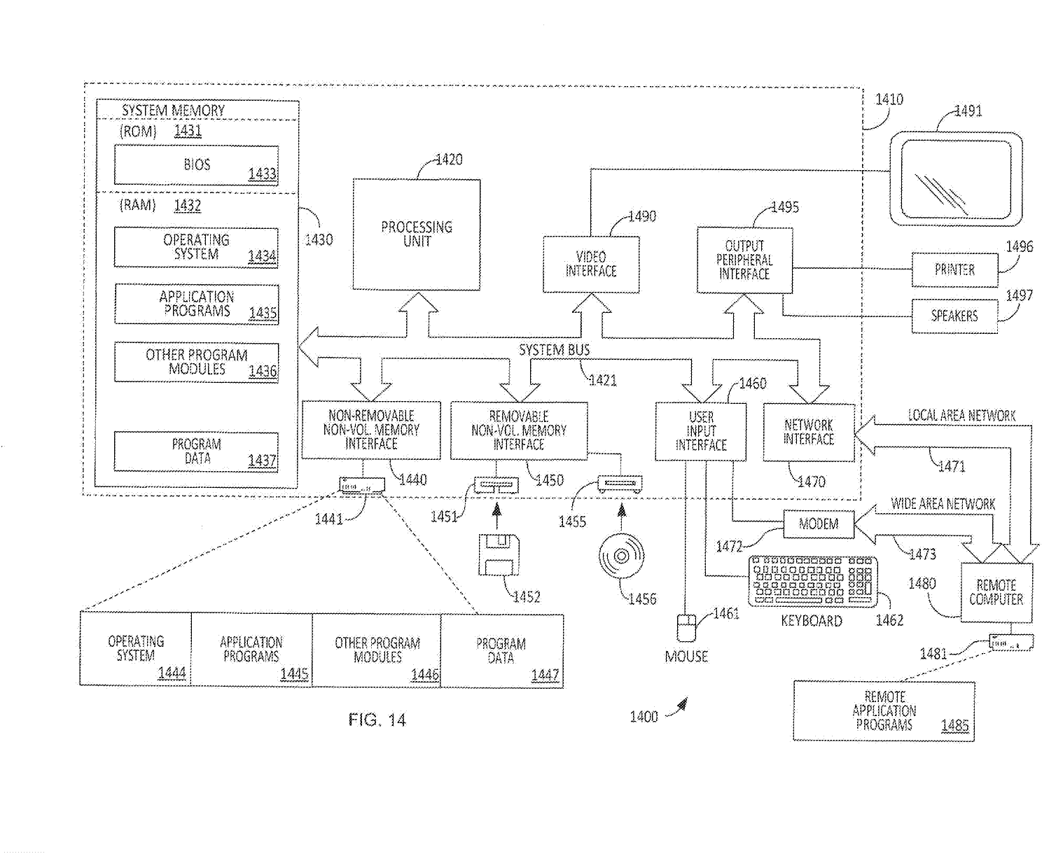

It should be appreciated from the foregoing that some aspects of the invention may be implemented via a computing system. FIG. 14 illustrates one example of a suitable computing system 1400 which may be used. The computing system 1400 is only one example of a suitable computing system, and is not intended to suggest any limitation as to the scope of use or functionality of the invention. Neither should the computing system 1400 be interpreted as having any dependency or requirement relating to any one or combination of components illustrated in the exemplary computing system 1400. In this respect, embodiments of the invention are operational with numerous other general-purpose or special-purpose computing systems or configurations. Examples of well-known computing systems and/or configurations that may be suitable for use with the invention include, but are not limited to, personal computers, server computers, mobile or laptop devices, multiprocessor systems, microprocessor-based systems, set top boxes, programmable consumer electronics, network PCs, minicomputers, mainframe computers, distributed computing systems that include any of the above systems or devices, and the like.

The computing system may execute computer-executable instructions, such as program modules. Generally, program modules include routines, programs, objects, components, data structures, etc. that perform particular tasks or implement particular abstract data types. The invention may also be practiced in distributed computing systems where tasks are performed by remote processing devices that are linked through a communications network. In a distributed computing system, program modules may be located in both local and remote computer storage media including memory storage devices.

FIG. 14 depicts a general purpose computing device in the form of a computer 1410. Components of computer 1410 may include, but are not limited to, a processing unit 1420, a system memory 1430, and a system bus 1421 that couples various system components including the system memory to the processing unit 1420. The system bus 1421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1410 typically includes a variety of computer readable media. Computer readable media can be any available media that can be accessed by computer 1410 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other one or more media which may be used to store the desired information and may be accessed by computer 1410. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared and other wireless media. Combinations of the any of the above should also be included within the scope of computer readable media.

The system memory 1430 includes computer storage media in the form of volatile and/or nonvolatile memory such as read only memory (ROM) 1431 and random access memory (RAM) 1432. A basic input/output system 1433 (BIOS), containing the basic routines that help to transfer information between elements within computer 1410, such as during start-up, is typically stored in ROM 1431. RAM 1432 typically contains data and/or program modules that are immediately accessible to and/or presently being operated on by processing unit 1420. By way of example, and not limitation, FIG. 14 illustrates operating system 1434, application programs 1435, other program modules 1436, and program data 1437.

The computer 1410 may also include other removable/non-removable, volatile/nonvolatile computer storage media. By way of example only, FIG. 14 illustrates a hard disk drive 1441 that reads from or writes to non-removable, nonvolatile magnetic media, a magnetic disk drive 1451 that reads from or writes to a removable, nonvolatile magnetic disk 1452, and an optical disk drive 1455 that reads from or writes to a removable, nonvolatile optical disk 1456 such as a CD ROM or other optical media. Other removable/non-removable, volatile/nonvolatile computer storage media that can be used in the exemplary computing system include, but are not limited to, magnetic tape cassettes, flash memory cards, digital versatile disks, digital video tape, solid state RAM, solid state ROM, and the like. The hard disk drive 1441 is typically connected to the system bus 1421 through an non-removable memory interface such as interface 1440, and magnetic disk drive 1451 and optical disk drive 1455 are typically connected to the system bus 1421 by a removable memory interface, such as interface 1450.

The drives and their associated computer storage media discussed above and illustrated in FIG. 14, provide storage of computer readable instructions, data structures, program modules and other data for the computer 1410. In FIG. 14, for example, hard disk drive 1441 is illustrated as storing operating system 1444, application programs 1445, other program modules 1446, and program data 1447. Note that these components can either be the same as or different from operating system 1434, application programs 1435, other program modules 1436, and program data 1437. Operating system 1444, application programs 1445, other program modules 1446, and program data 1447 are given different numbers here to illustrate that, at a minimum, they are different copies. A user may enter commands and information into the computer 1410 through input devices such as a keyboard 1462 and pointing device 1461, commonly referred to as a mouse, trackball or touch pad. Other input devices (not shown) may include a microphone, joystick, game pad, satellite dish, scanner, or the like. These and other input devices are often connected to the processing unit 1420 through a user input interface 1460 that is coupled to the system bus, but may be connected by other interface and bus structures, such as a parallel port, game port or a universal serial bus (USB). A monitor 1491 or other type of display device is also connected to the system bus 1421 via an interface, such as a video interface 1490. In addition to the monitor, computers may also include other peripheral output devices such as speakers 1497 and printer 1496, which may be connected through a output peripheral interface 1495.

The computer 1410 may operate in a networked environment using logical connections to one or more remote computers, such as a remote computer 1480. The remote computer 1480 may be a personal computer, a server, a router, a network PC, a peer device or other common network node, and typically includes many or all of the elements described above relative to the computer 1410, although only a memory storage device 1481 has been illustrated in FIG. 14. The logical connections depicted in FIG. 14 include a local area network (LAN) 1471 and a wide area network (WAN) 1473, but may also include other networks. Such networking environments are commonplace in offices, enterprise-wide computer networks, intranets and the Internet.

When used in a LAN networking environment, the computer 1410 is connected to the LAN 1471 through a network interface or adapter 1470. When used in a WAN networking environment, the computer 1410 typically includes a modem 1472 or other means for establishing communications over the WAN 1473, such as the Internet. The modem 1472, which may be internal or external, may be connected to the system bus 1421 via the user input interface 1460, or other appropriate mechanism. In a networked environment, program modules depicted relative to the computer 1410, or portions thereof, may be stored in the remote memory storage device. By way of example, and not limitation, FIG. 14 illustrates remote application programs 1485 as residing on memory device 1481. It will be appreciated that the network connections shown are exemplary and other means of establishing a communications link between the computers may be used.

Embodiments of the invention may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the invention discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the present invention as discussed above. As used herein, the term “computer-readable storage medium” encompasses only a tangible machine, mechanism or device from which a computer may read information. Alternatively or additionally, the invention may be embodied as a computer readable medium other than a computer-readable storage medium. Examples of computer readable media which are not computer readable storage media include transitory media, like propagating signals.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

The invention may be embodied as a method, of which an example has been described. The acts performed as part of the method may be ordered in any suitable way. Accordingly, embodiments may be constructed in which acts are performed in an order different than illustrated, which may include different acts than those which are described, and/or which may involve performing some acts simultaneously, even though the acts are shown as being performed sequentially in the embodiments specifically described above.

Use of ordinal terms such as “first,” “second,” “third,” etc., to modify an element does not by itself connote any priority, precedence, or order of one element over another or the temporal order in which acts of a method are performed, but are used merely as labels to distinguish one element having a certain name from another element having a same name (but for use of the ordinal term) to distinguish the elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A computing system, comprising:
at least one server component, coupled to at least one communications network, the at least one server component being programmed to:
send a notification via the at least one communications network to a client device associated with a traveler, the notification indicating that a first time, at which a ride requested by the traveler with a ridesharing service is to commence, is approaching;
receive an indication from the client device associated with the traveler that the ride is to instead commence at a second time, subsequent to the first time; and
in response to receiving the indication, cause a request to be submitted to the ridesharing service on behalf of the traveler for a ride to commence at the second time.

2. The computing system of claim 1, wherein the at least one server component is programmed to send the notification to the client device prior to a request for the ride being submitted to the ridesharing service.

3. The computing system of claim 1, wherein the at least one server component is programmed to send the notification to the client device prior to a driver affiliated with the ridesharing service accepting the ride.

4. The computing system of claim 1, wherein the at least one server component is programmed to send a plurality of notifications to the client device, each of the plurality of notifications being sent at a different time interval prior to the first time.

5. The computing system of claim 1, wherein the at least one server component is programmed to receive an indication from the client device associated with the traveler that at least one of an origin location for the ride, a destination location for the ride, and the ridesharing service are to be changed.

6. The computing system of claim 1, wherein the at least one server component is programmed to receive an indication that the ride is to be delayed by a predefined amount of time.

7. The computing system of claim 1, wherein the ridesharing service does not accept a request for a ride more than a predetermined amount of time before a ride is to commence, and wherein the at least one server component is programmed to accept a request for the ride more than the predetermined amount of time prior to the first time.

8. The computing system of claim 1, further comprising one or more of the client device associated with the traveler and the at least one communications network.

9. A computing system, comprising:
at least one server component, coupled to at least one communications network, the at least one server component being programmed to:
send a notification via the at least one communications network to a client device associated with a traveler, the notification indicating that a first time is approaching, the first time being a time at which a ride requested by the traveler with a ridesharing service is to commence, wherein the ride is to involve the traveler being picked up at a pickup location by a driver affiliated with the ridesharing service;
receive an indication from the client device associated with the traveler that the traveler will not be at the pickup location by the first time; and
send information to the client device associated with the traveler, the information enabling the client device associated with the traveler to communicate directly with a client device associated with the driver, so as to request that the driver wait at the pickup location until a second time subsequent to the first time.

10. The computing system of claim 9, wherein the at least one server component is programmed to send information to the client device associated with the traveler which enables the client device associated with the traveler to call the client device associated with the driver.

11. The computing system of claim 9, wherein the at least one server component is programmed to send information to the client device associated with the traveler which enables the client device associated with the traveler to send a text message comprising predefined content to the client device associated with the driver.

12. The computing system of claim 9, wherein the at least one server component is programmed to:
receive an indication from the client device associated with the traveler that the ride is to be cancelled and that another ride is to be requested; and
send a request to the ridesharing service for the other ride.

13. The computing system of claim 9, wherein the at least one server component is programmed to send a plurality of notifications to the client device associated with the traveler, each of the plurality of notifications being sent at a different time interval prior to the first time.

14. The computing system of claim 9, wherein the ridesharing service does not accept a request for a ride more than a predetermined amount of time before a ride is to commence, and wherein the at least one server component is programmed to accept a request for the ride more than the predetermined amount of time prior to the first time.

15. The computing system of claim 9, further comprising one or more of the client device associated with the traveler and the at least one communications network.
